(19) United States
(12) Patent Application Publication
(10) Pub. No.: US 2007/0139133 A1
(43) Pub. Date: Jun. 21, 2007

(54) Apparatus for converting transmission structure

(75) Inventors: Do-hoon Kwon, Seoul (KR); Young-eil Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/603,052

(22) Filed: Nov. 22, 2006

(30) Foreign Application Priority Data
Dec. 19, 2005 (KR) 10-2005-125546

(51) Int. Cl. H01P 5/02

(52) U.S. Cl. 333/33

(57) ABSTRACT

An apparatus for converting a transmission structure includes a conductor-backed coplanar waveguide (CBCPW) transmission line comprising metal layers formed on both sides of a board, a first signal line and a first ground line formed by removing the metal layer on one side of the board according to a pattern line, a plurality of via holes formed on the first ground line, proximate to the pattern line, and a parallel transmission line which forms a second signal line and a second ground line parallel with the second signal line, by being connected at one end with the first signal line and the first ground line in a substantially perpendicular direction with respect to the board, respectively. By the parallel transmission line which is connected with the planar transmission line in a perpendicular direction, a compact-sized wideband converter can be provided at an economical price.

### CROSS-REFERENCE TO RELATED APPLICATION

This application claims priority from Korean Patent Application No. 2005-125546, filed Dec. 19, 2005, in the Korean Intellectual Property Office, the entire contents of which are incorporated herein by reference.

### BACKGROUND OF THE INVENTION

1. Field of the Invention

The present invention relates to an apparatus for converting transmission structure. More particularly, the present invention relates to an apparatus for converting transmission structure by changing a vertical feed to a horizontal feed of the board in a wideband operation.

2. Description of the Related Art

A balun converts signals between unbalanced signals and balanced signals, and is mainly used in devices such as balanced mixers, balanced amplifiers, phase shifters, antenna feeds and antenna connectors and low noise amplifiers.

Baluns are generally categorized as active baluns and passive baluns. The active balun uses elements, while the passive balun uses coaxial cables, coplanar waveguides (CPW) and microstrip lines. Because the active balun usually has drawbacks such as high DC power consumption and high noise, passive baluns are more popularly used.

The passive balun is set up by coupling two directional couplers, and usually uses a planar type microstrip line structure such as a microstrip coupled with a slot line, a CPW coupled with a slot line, and a CPW coupled to a CPW.

FIG. 1 is a plan view showing a transmission line of a general microstrip structure, and FIG. 2 is a plan view showing a general CPW transmission line.

Referring to FIG. 1, a microstrip structure transmission line includes a board 10, and a strip type signal line 20 formed in the middle of the board 10. Although not shown in FIG. 1, there is a ground side on the lower side of the board 10.

Referring to FIG. 2, a CPW transmission line mainly includes a strip type signal line 40 in the middle of the board, and ground lines 30 on both sides of the signal line 40.

The way of coupling a pair of microstrip type transmission lines as shown in FIG. 1 will be explained below.

A pair of microstrip transmission lines are arranged in perpendicular relations with each other, and coupled to the ground side. In order to couple the board of horizontal arrangement with the board of vertical arrangement, a part of one of the boards needs be removed, and it also requires that the transmission line be lengthened.

In order to couple the transmission line of the microstrip structure of FIG. 1 with the transmission line of CPW structure of FIG. 2, the CPW signal line 40 and the microstrip signal line 20 are arranged in a perpendicular relation to each other. Then the CPW signal line 40, the microstrip signal line 20, the CPW ground line 30 and the microstrip ground line are connected to each other. Because the ground side has a large area and occupies a large space, the coupling of the microstrip signal line 20 and the ground side, and the coupling of the CPW signal line 40 and the ground line 30 is difficult.

In order to overcome the above-mentioned problems, it has been suggested that a separate parallel strip transmission line be connected to the CPW structure transmission line. By doing so, the signal is transmitted through a pair of parallel strip transmission lines, each being connected with the CPW signal line 40 and the ground line 30, and therefore, loses in the wideband can be reduced.

However, because the CPW transmission line emits electro-magnetic fields not only in the board, but also in the air of the upper and lower parts of the board, there always exists a possibility that the high frequency circuit on the board causes interference with the radiating electro-magnetic field of the antenna.

### SUMMARY OF THE INVENTION

Illustrative, non-limiting exemplary embodiments of the present invention overcome the above disadvantages and other disadvantages not described above. Also, the exemplary embodiments of the present invention are not required to overcome the disadvantages described above, and an illustrative, non-limiting exemplary embodiment of the present invention may not overcome any of the problems described above.

An aspect of the present invention provides an apparatus for converting transmission structure, which connects a board-type transmission line having a ground side with a parallel transmission line in a perpendicular manner such that the perpendicular power feed of the board is converted to a horizontal direction and both sides of the ground side are electro-magnetically separated.

The above aspects and/or other features of the present invention can substantially be achieved by providing an apparatus for converting a transmission structure, comprising: a conductor-backed coplanar waveguide (CBCPW) transmission line comprising metal layers formed on both sides of a board, a first signal line and a first ground line formed by removing the metal layer on one side of the board according to a predetermined pattern line; a plurality of via holes formed on the first ground line, proximate to the pattern line; and a parallel transmission line forming a second signal line and a second ground line parallel with the second signal line, by being connected at one end with the first signal line and the first ground line in a substantially perpendicular direction with respect to the board, respectively.

The pattern line may comprise a substantially ‘⊂’ configuration, which is open at one end to correspond to one end of the board.

The via holes may comprise: a first via hole formed along a substantially lengthwise direction of the pattern line to electrically connect the metal layers on the upper and lower sides of the board together; and a second via hole formed along a substantially widthwise direction of the pattern line to electrically connect the metal layers and the second ground line.

The parallel transmission line may substantially comprise a strip configuration. The parallel transmission line may comprise a fixing pad which is extended from one end in a substantially horizontal direction with respect to the board.

The second signal line may have substantially the same width as the first signal line. The second ground line may have substantially the same width as the first signal line.

According to an aspect of the present invention, an apparatus for converting a transmission structure, comprises a microstrip transmission line comprising a signal line and a conductor surface on one side of a board, and a ground surface on the other side of the board, the signal line being extended from one end of the board by a predetermined distance, and the conductor surface being distanced away from the signal line by a predetermined distance; a plurality of via holes formed on the conductor surface, proximate to the signal line; and a parallel transmission line forming a parallel signal line and a parallel ground line parallel to the parallel signal line, by being connected at one end to the signal line and the conductor surface in a substantially perpendicular direction with respect to the board.

The parallel transmission line may substantially comprise a strip configuration. The parallel transmission line may comprise a fixing pad which is extended from one end in a substantially horizontal direction with respect to the board.

The parallel signal line may have the same width as the signal line. The parallel ground line has the same width as the ground line.

### BRIEF DESCRIPTION OF THE DRAWINGS

The above aspects of the present invention will become more apparent by describing in detail certain exemplary embodiments thereof with reference to the attached drawings, in which:

FIG. 1 is a plan view of a conventional microstrip structure transmission line;

FIG. 2 is a plan view of a conventional coplanar waveguide (CPW) structure transmission line;

FIG. 3 is a view of a conductor-backed coplanar waveguide (CBCPW) transmission line according to an exemplary embodiment of the present invention;

FIG. 4 is a view illustrating connecting structure between a CPW transmission line and a parallel transmission line;

FIGS. 5A and 5B are views of electro-magnetic fields of a CBCPW transmission line and a parallel transmission line according to an exemplary embodiment of the present invention;

FIG. 6 is a view of a microstrip transmission line according to an exemplary embodiment of the present invention;

FIG. 7 is a view illustrating a connecting structure between a microstrip transmission line and a parallel transmission line;

FIGS. 8A through 8C are views illustrating a structure for measuring structure conversion performance of CBCPW structure according to an exemplary embodiment of the present invention, and the result of the measurement; and

FIGS. 9A through 9C are views illustrating a structure for measuring structure conversion performance of microstrip structure according to an exemplary embodiment of the present invention, and the result of the measurement.

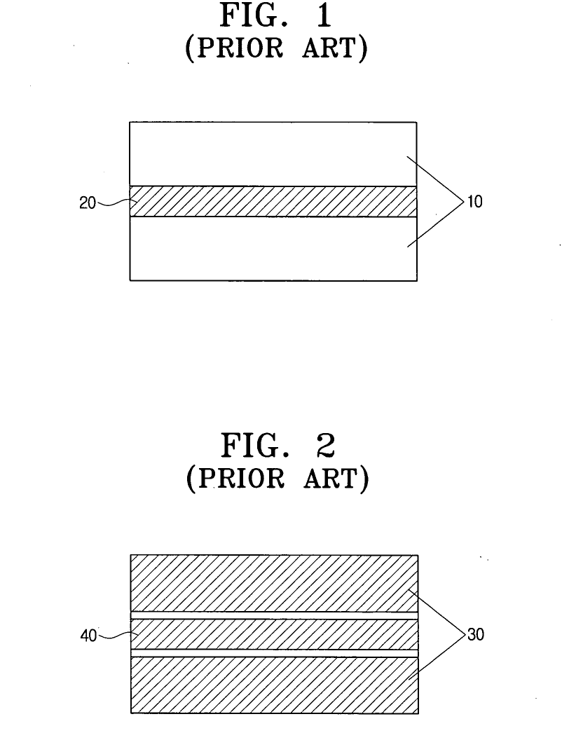

### DESCRIPTION OF EXEMPLARY EMBODIMENTS

Hereinafter, the exemplary embodiments of the present invention will be described in detail with reference to the drawings.

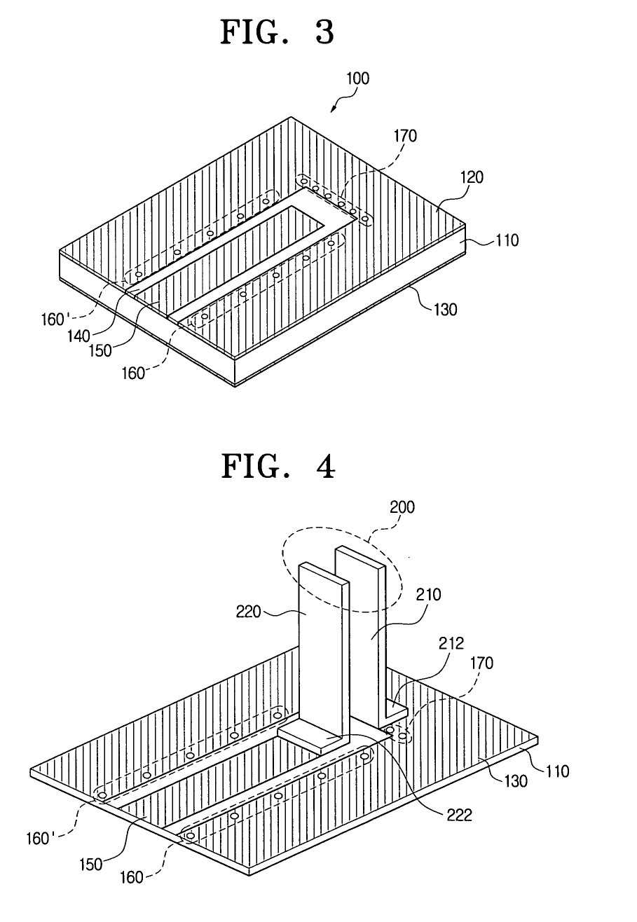

FIG. 3 shows a conductor-backed coplanar waveguide (CBCPW) transmission line according to an exemplary embodiment of the present invention.

The CBCPW transmission line 100 has the same upper structure as the coplanar waveguide transmission line, but is different that it has a ground surface 130 also on the lower part 110 of the board.

A CBCPW transmission line 100 according to an exemplary embodiment of the present invention has metal layers on the upper and lower sides of the board 110. The metal layer on one side of the board 110 forms a first ground line 120 and a first signal line 150, while the metal layer on the other side of the board 110 forms a ground surface 130. The metal layer may be formed by a copper coating.

A predetermined pattern line 140 is provided, and the metal layer of one side of the board 110 is removed in order to form the first signal line 150 and the first ground line 120. Accordingly, the first signal line 150 is defined within the predetermined pattern line 140, while the first ground line 120 is formed outside the pattern line 140 and surrounds the first signal line 150. The pattern line 140 may be formed in the shape of ‘⊂’, which is open on one side to correspond to one end of the board 110.

The first signal line 150 has a predetermined length and is surrounded by the first ground line 120. Therefore, the first signal line 150 can be provided as an open circuit on the CBCPW transmission line 100.

In order to electrically connect the first ground line 120 to the ground surface 130, a plurality of first via holes 160 and 160′ and second via holes 170 are formed in the first ground line 120, in an arrangement surrounding the predetermined pattern line 140. The via holes 160, 160′, and 170 are formed proximate to the predetermined pattern line 140.

The first via holes 160 and 160′ are formed on both sides of the predetermined pattern line 140 on the first ground line 120 in a lengthwise direction, to electrically connect the first ground line 120 with the ground surface 130.

The second via holes 170 are formed in a widthwise direction of the predetermined pattern line 140 on the first ground line 120, to electrically connect the first ground line 120, the ground surface 130 and the second ground line of the parallel transmission line which will be described in detail below.

As a result, the first signal line 150 is completely surrounded by the first via holes 160 and 160′, and the second via holes 170, which are respectively formed in lengthwise and widthwise directions of the predetermined pattern line 140 on the first ground line 120.

With reference to FIG. 3, the CPW transmission line 100 according to an exemplary embodiment of the present invention, employs a ‘⊂’-shaped pattern line 140, which is open at one end to correspond to one end of the board 110, to form the first ground line 120 and the first signal line 150. This is an unbalanced transmission line which has the first ground line 120 and the first signal line 150 at different configurations from each other.

FIG. 4 is a view illustrating the connection structure between the CPW transmission line and the parallel transmission line.

More specifically, FIG. 4 shows the connection structure of the parallel transmission line connected with a CBCPW transmission line 100 in a vertical relation with respect to the board 110, in which the CBCPW transmission line 100 includes the first ground line 120 and the first signal line 150 formed on one side of the board 110, and the ground surface 130 formed on the other side of the board 110.

The parallel transmission line 200 includes a strip type second ground line 210 and a strip type second signal line 220 in parallel relations to each other. Because there is an air layer generated between the second ground line 210 and the second signal line 220 of the parallel transmission line 200, no dielectric board is additionally required.

The second ground line 210 is provided as a strip type and is connected to the upper part of the second via holes 170 of the first ground line 120 in a perpendicular manner with respect to the board 110. The second ground line 210 has the same width as the first signal line 150.

Like the second ground line 210, the second signal line 220 is provided as a strip type. The second signal line 220 is coupled in a perpendicular relation with respect to the board 110 to correspond with the second ground line 210 on the first signal line 150. The second signal line 220 has the same width as the first signal line 150. That is, the first signal line 150, the second ground line 210 and the second signal line 220 are formed with the same width.

The second signal line 220 and the second ground line 210 include fixing pads 212 and 222 which are bent in a perpendicular direction from one end and extend by a predetermined width. The fixing pads 212 and 222 help the second signal line 220 and the second ground line 210 to be more firmly coupled to the first signal line 150 and the first ground line 120.

As shown in FIG. 4, the second ground line 210 and the second signal line 220 of the parallel transmission line 200 are identical in their structure and provided in a symmetrical arrangement. Therefore, this is a balanced transmission line. Because the apparatus for converting transmission structure operates to convert CBCPW or microstrip unbalanced transmission line into a balanced parallel transmission line, it can operate as a balun.

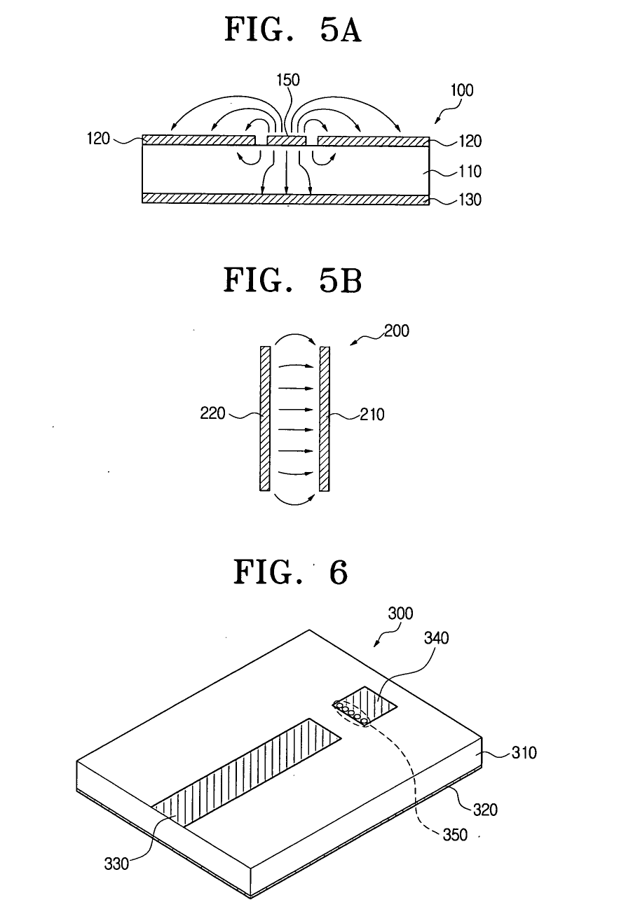

FIGS. 5A and 5B are views illustrating electro-magnetic fields in the CBCPW transmission line and the parallel transmission line.

FIG. 5A shows the electro-magnetic field in the CBCPW transmission line 100 in section. As shown, the CBCPW transmission line 100 has the first signal line 150 in the middle part of the upper side of the board 110, the first ground line 120 on both sides of the board 110 which are at a predetermined distance from the first signal line 150, respectively, and the ground surface 130 on the lower side of the board 110.

The electro-magnetic field at the upper side of the board 110 is in the direction from the first signal line 150 in the middle toward the first ground lines 120 on both sides. The electro-magnetic field within the board 110 is in the direction from the first signal line 150 toward the ground surface 130, that is, in the direction from the upper inner side toward the lower inner side of the board 110. Due to the ground surface 130 formed on the lower side of the board 110, the electro-magnetic field within the board 110 does not leak out of the board 110.

The CBCPW transmission line 100 with the ground surface 130 has the structure in which the electro-magnetic field is completely isolated by the presence of the ground surface 130. Therefore, there is no electro-magnetic interference between the upper and lower surfaces of the board 110.

FIG. 5B shows the electro-magnetic field of the parallel transmission line 200 in section. As shown, the parallel transmission line 200 includes the second ground line 210 and the second signal line 220 which are formed in the same pattern and face each other. There is an electro-magnetic field in the direction from the second signal line 220 toward the second ground line 210 in the parallel transmission line 200.

With the apparatus for converting transmission structure of CBCPW transmission line 100 according to an exemplary embodiment of the present invention, the electro-magnetic field such as the one shown in FIG. 5A for the CBCPW transmission line 100 is converted to the one as shown in FIG. 5B for the parallel transmission line 200.

FIG. 6 shows a microstrip transmission line according to another exemplary embodiment of the present invention.

A signal line 330 of a predetermined width and length is formed on an upper side of a board 310, with one end extending toward the center of the board 310, and a conductor 340 of the same width as the signal line 330 is formed at a predetermined distance away from the signal line 330.

A plurality of via holes 350 are formed along one side of the conductor surface 340, in a location proximate to the signal line 330. The via holes 350 electrically connect the ground surface 320, the conductor surface 340 and a parallel ground line of a parallel transmission line which will be described in detail below.

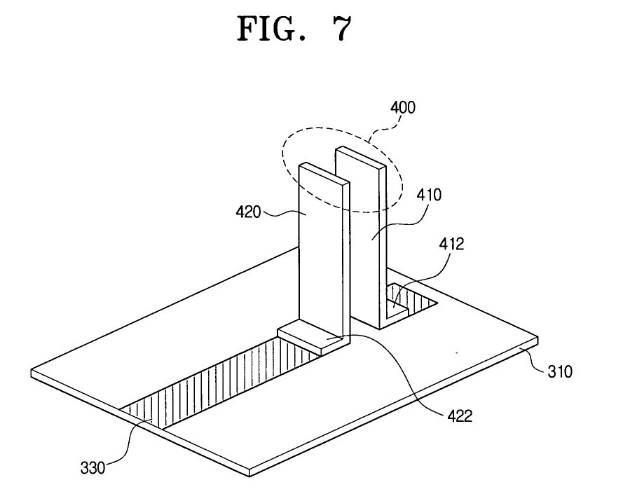

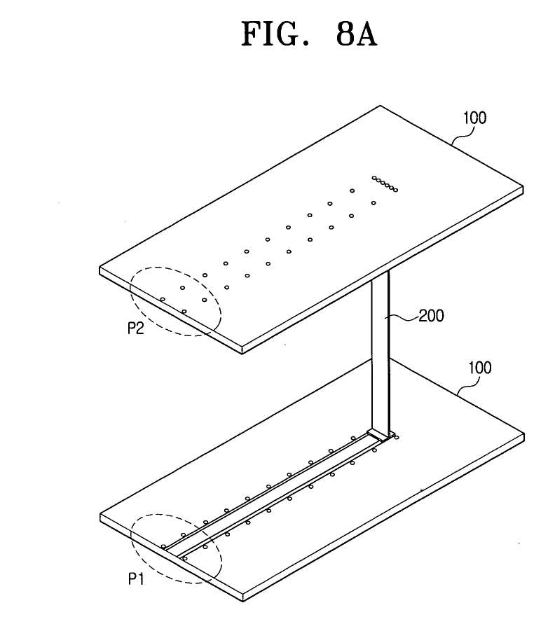

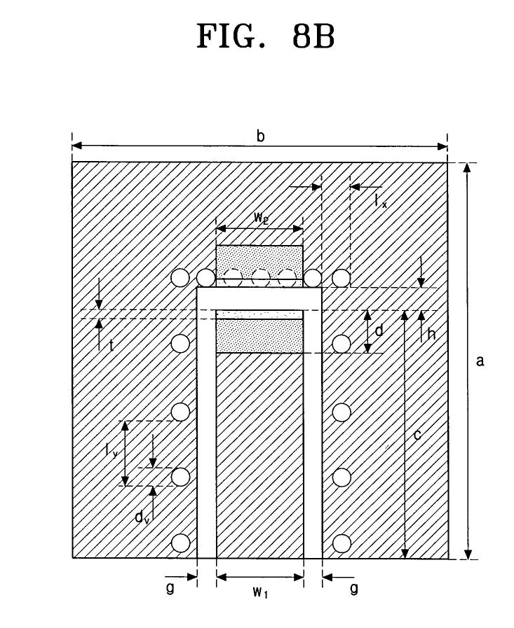

FIG. 7 shows a coupling structure of a microstrip transmission line and a parallel transmission line.

More specifically, FIG. 7 shows the connection structure of the parallel transmission line 400 with the microstrip transmission line 300 in a vertical relation with respect to the board 310, in which the microstrip transmission line 300 includes the signal line 330 and the conductor surface 340 formed on one side of the board 310, and the ground surface 320 formed on the other side of the board 310.

The parallel transmission line 400 applied to the microstrip structure has the same structure as the parallel transmission line 200 applied to the CBCPW structure as shown in FIG. 4, but the respective elements are given different reference numerals for the convenience of understanding.

The parallel transmission line 400 includes a parallel ground line 410 and a parallel signal line 420, which are formed opposite to each other. The parallel ground line 410 is connected to the upper part of the via holes 350 formed near the conductor surface 340, and the parallel signal line 420 is connected in parallel relation with the parallel ground line 410 at the signal line 330.

Fixing pads 412 and 422 are bent at one end of the parallel ground line 410 and the parallel signal line 420, and extended by a predetermined width, respectively. The fixing pad 412 helps the parallel ground line 410 to be coupled more firmly to the conductor surface 340, and the fixing pad 422 helps the parallel signal line 420 to be coupled more firmly to the signal line 330.

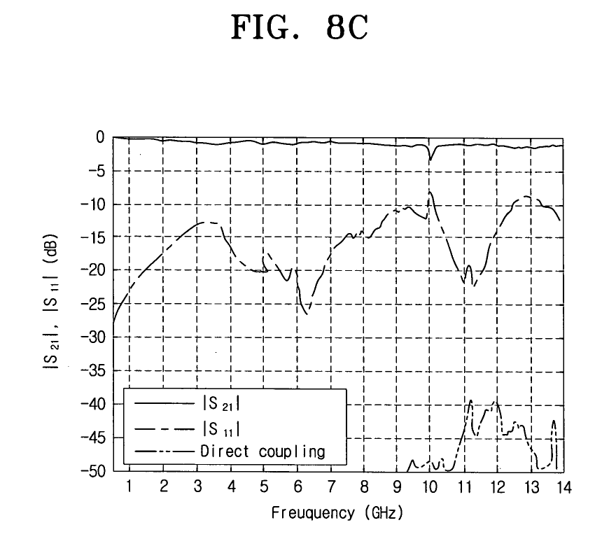

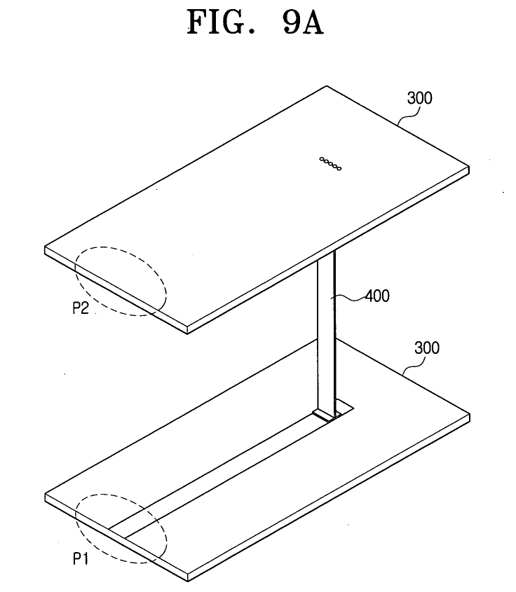

FIGS. 8A through 8C show the structure for measuring structure conversion performance of the CBCPW transmission structure, and the result of these measurements.

FIG. 8A shows a pair of CBCPW transmission lines 100 arranged opposite to each other in a horizontal direction, and one parallel transmission line 200 coupled to the CBCPW transmission lines 100.

The technique employed in FIG. 8A, which connects two converters in series, and has two transmission structure converting apparatuses facing each other, with the same type of measurement ports, is well-known in the related art.

The board 110 is 0.813 mm in thickness (tₛ), and the metal layer on the upper and lower sides of the board 110 is 0.034 mm in thickness including the thickness of copper coated thereon. The parallel transmission line 200 is 30 mm in length.

FIG. 8B shows, in section, a structure converting apparatus of CBCPW transmission structure 100 having the parallel transmission line 200 as shown in FIG. 4. The respective parameters of the CBCPW transmission structure conversion apparatus are as follows.

TABLE 1

Parameters

| | tₛ | a | b | c | w₁ | g |
|---|---|---|---|---|---|---|
| Size (mm) | 0.813 | 50.0 | 40.0 | 30.0 | 1.5 | 0.36 |

Parameters

| | d | t | h | dᵥ | lₓ | l_{y} |
|---|---|---|---|---|---|---|
| Size (mm) | 1.0 | 0.25 | 0.24 | 0.3 | 0.6 | 3.0 |

The effect of CBCPW transmission structure converting apparatus as shown in FIGS. 8A and 8B is shown in FIG. 8C, which graphically shows the result of S (scattering) parameter measurements in an example of using two ports.

The ‘scattering’ parameters are widely used in RF field, and it means the ratio of output power versus input power at a predetermined frequency. S₂₁ is the transfer coefficient from the first port P1 to the second port P2, and S₁₁ is the reflect coefficient of the first port P1. The wideband transmission suffers less loss as |S₁₁| is smaller and |S₂₁| is larger.

Referring to FIG. 8C, when a pair of CBCPW transmission lines 100 and one parallel transmission line 200 are employed, the loss of insertion is below 1.6 dB (|S₂₁|.−1.6 dB) in the frequency range of 0.5 through 14 GHz. The reflection loss is more than 7.8 dB (|S₁₁|,−7.8 dB) in the frequency range of 0.5 through 14 GHz. Therefore, conversion of wideband transmission structure is possible with low loss.

The insertion loss of direct coupling of a pair of CBCPW transmission lines 100 and the parallel transmission line 200 is also shown, in which the very low measurement of the direct coupling value shows that substantially all of the power transmitted from one CBCPW transmission line 100 to the other is transmitted via the parallel transmission line 200 provided therebetween.

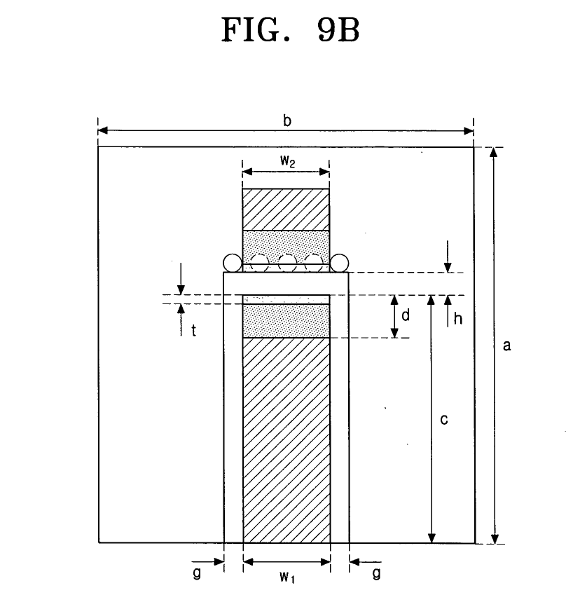

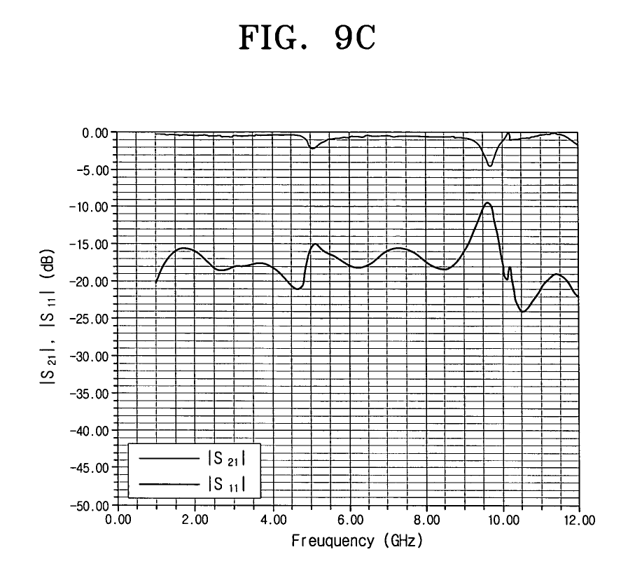

FIGS. 9A through 9C show the structure for measuring the microstrip structure conversion performance according to an exemplary embodiment of the present invention, and the result of the measurement.

FIG. 9A shows the structure comprising a pair of microstrip transmission lines 300 formed opposite to each other, and one parallel transmission line 400 connecting the microstrip transmission lines 300. A board 310 of the microstrip transmission lines 300 is 0.813 mm in thickness (tₛ), and 20 mm×40 mm in size. The metal layer of 0.034 mm including the thickness of the copper coated thereon, is formed on the lower side of the board 310, and thus it forms a ground surface 320.

FIG. 9B shows in section a microstrip transmission structure converting apparatus according to an exemplary embodiment of the present invention, in which the parallel transmission line 400 of FIG. 7 is connected with the microstrip transmission line 300. In FIG. 9B, the respective parameters are indicated. The parameters are the same as those listed in Table I above. The parallel transmission line 400 is 30 mm in length, and the parallel ground line 410 and the parallel signal line 420 of the parallel transmission line 400 are at a distance of 0.28 mm apart from each other.

FIG. 9C shows the effect of the microstrip structure converting apparatus as shown in FIGS. 9A and 9B, in which the results of S parameter measurement in the example of using two ports, are shown.

Referring to FIG. 9C, the insertion loss is below 1.8 dB in the frequency band excluding 5 GHz and 10 GHz. Compared to this, the insertion loss of the example of using one microstrip transmission line 300 is below 0.9 dB.

The increase of insertion losses at the frequency of 5 GHz and 10 GHz is due to the interaction between the two microstrip transmission lines 300, but this does not influence the conversion performance.

In conclusion, by the parallel transmission line 200 or 400, which is perpendicularly connected with the CBCPW transmission line 100 or the microstrip transmission line 300, it is possible to convert the power feed from the perpendicular to horizontal direction with respect to the board 110 or the board 310 in the wideband.

Additionally, because the CBCPW transmission line 100 and the microstrip transmission line 300 are structured to have ground surface 130 or 320 on the lower side of the board 110 or 310, the electro-magnetic field is completely separated by the ground surfaces 130, 320. Therefore, by mounting an antenna on one side of the board 110 or 310 and constructing an RF circuit on the other side of the board 110 or 310, radiation of electric waves and interferences with RF components can be completely prevented.

As described above, an apparatus for converting transmission structure according to the exemplary embodiments of the present invention employs a separate parallel transmission line to convert a planar transmission line to a parallel transmission line of perpendicular direction in a wideband. Additionally, because the board is prevented from sustaining possible damage and because there is no need to extend the transmission line, the wideband converting apparatuses can be provided at an economical price.

Furthermore, because the upper and the lower parts of the board are completely separated from each other by the ground surface on the planar transmission line, when an antenna is employed, radiation of electric waves and interferences with RF components can be prevented.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. An apparatus for converting a transmission structure, comprising:
a conductor-backed coplanar waveguide (CBCPW) transmission line comprising metal layers formed on the upper and lower sides of a board;
a first signal line and a first ground line; and
a parallel transmission line which forms a second signal line and a second ground line parallel with the second signal line, by being connected at one end with the first signal line and the first ground line in a substantially perpendicular direction with respect to the board, respectively.

2. The apparatus of claim 1, wherein the first signal line and the first ground line are arranged according to a predetermined pattern line.

3. The apparatus of claim 2, wherein the conductor-backed coplanar waveguide (CBCPW) further comprises a plurality of via holes formed on the first ground line, proximate to the pattern line.

4. The apparatus of claim 3, wherein the pattern line comprises a substantially ‘⊂’ configuration, which is open at one end to correspond to one end of the board.

5. The apparatus of claim 3, wherein the via holes comprise:
a first via hole formed along a substantially lengthwise direction of the pattern line to electrically connect the metal layers on both sides of the board together; and
a second via hole formed along a substantially widthwise direction of the pattern line to electrically connect the metal layers and the second ground line.

6. The apparatus of claim 1, wherein the parallel transmission line comprises a substantially strip configuration.

7. The apparatus of claim 6, wherein the parallel transmission line comprises a fixing pad which is extended from said one end in a substantially horizontal direction with respect to the board.

8. The apparatus of claim 1, wherein the second signal line has substantially a same width as the first signal line.

9. The apparatus of claim 1, wherein the second ground line has substantially a same width as the first signal line.

10. An apparatus for converting a transmission structure, comprising:
a microstrip transmission line comprising a signal line and a conductor surface on one side of a board, and a ground surface on the other side of the board, the signal line being extended from one end of the board by a predetermined distance, and the conductor surface being distanced away from the signal line by a predetermined distance;
a plurality of via holes formed on the conductor surface, proximate to the signal line; and
a parallel transmission line which forms a parallel signal line and a parallel ground line parallel to the parallel signal line, by being connected at one end to the signal line and the conductor surface in a substantially perpendicular direction with respect to the board.

11. The apparatus of claim 10, wherein the parallel transmission line comprises a substantially strip configuration.

12. The apparatus of claim 11, wherein the parallel transmission line comprises a fixing pad which is extended from said one end in a substantially horizontal direction with respect to the board.

13. The apparatus of claim 10, wherein the parallel signal line has the same width as the signal line.

14. The apparatus of claim 10, wherein the parallel ground line has a same width as the ground line.
